(19) United States
(12) Patent Application Publication
(10) Pub. No.: US 2023/0130536 A1
(43) Pub. Date: Apr. 27, 2023

(54) BALL JOINT TRACTOR

(71) Applicant: BlackSeries Intelligent Equipment (Weihai) Co., Ltd, Weihai (CN)

(72) Inventors: Xinna LIU, Weihai (CN); Zhuhua SUN, Weihai (CN); Xuxin DU, Weihai (CN); Guang XU, Weihai (CN)

(21) Appl. No.: 17/740,879

(22) Filed: May 10, 2022

(30) Foreign Application Priority Data
Oct. 21, 2021 (CN) 2021112262753

(51) Int. Cl. B60D 1/06; B60D 1/26; B60D 1/60

(52) U.S. Cl. CPC B60D 1/065; B60D 1/26; B60D 1/60

(57) ABSTRACT

A ball joint tractor with simple structure and convenient operation is disclosed. When docking is required, it will realize automatic locking, and there is no need for separate personnel to operate. Docking can be completed without getting off the vehicle. The pull ring spring plunger used in the disclosure can be directly inserted into the tractor from the outside of the tractor. When the pull ring spring plunger is damaged, it can be replaced directly without replacing the whole ball joint tractor, which improves the service efficiency of the equipment and avoids the failure of the whole ball joint tractor due to poor spring pin. In the disclosure, by placing the fixing ball in the ball joint groove for locking, the risk of automatic unlocking is avoided, and the safety performance is high and the traction effect is good.

### CROSS REFERENCE TO RELATED APPLICATION

This patent application claims the benefit and priority of Chinese Patent Application No. 202111226275.3 filed on Oct. 21, 2021, the disclosure of which is incorporated by reference herein in its entirety as part of the present application.

### TECHNICAL FIELD

The present disclosure relates to the technical field of the vehicle tractor, and more specifically, to a ball joint tractor.

### BACKGROUND ART

With the improvement of living standards and the rapid development of transportation, more and more people begin to like recreational vehicle (RV) travel. The trailer RV is generally driven by a tow vehicle through the tractor. After arriving at the ideal leisure place, the tow vehicle is separated from the RV. When leaving, the tow vehicle is connected with the RV through the tractor and driven away. Therefore, the tractor is often used as the connecting part between the trailer RV and the tow vehicle. There are many kinds of traction connection forms of tractor, usually including manual direct pin connection, manual ball shaft connection and so on. Construction machinery vehicles and industrial vehicles are usually connected by the manual direct pin, while off-road vehicles and RV are mostly connected by manual ball shaft when towing trailers. At present, the tractor used in the market is manual, that is, when the tractor is docked together, it needs to be locked manually, but it cannot be locked automatically when docking. It has complex structure, complicated operation, poor traction effect and poor safety, which will lead to the risk of automatic unlocking. At present, some ball joint tractors in the market use spring pins. As vulnerable parts, spring pins often fail to pop up normally or are deformed and damaged, resulting in the failure of the whole ball joint tractor due to poor spring pins.

### SUMMARY

In order to solve the above problems, a ball joint tractor is provided, which aims to solve the following problems. When the tractor is docked together, it needs to be locked manually, but it cannot be locked automatically when docking. It has complex structure, complicated operation, poor traction effect and poor safety, which will lead to the risk of automatic unlocking. At present, some ball joint tractors in the market use spring pins. As vulnerable parts, spring pins often fail to pop up normally or are deformed and damaged, resulting in the failure of the whole ball joint tractor due to poor spring pins.

The embodiments of the disclosure provide a ball joint tractor. The ball joint tractor is provided with a traction cap. The traction cap is movably connected with a traction shaft sleeve. The traction shaft sleeve is arranged in a cylindrical hollow shape. A traction ball joint can be inserted in a middle of the traction shaft sleeve. The traction cap is provided with a spring plunger mounting hole penetrating through a traction cap cylinder wall. And the ball joint tractor is further provided with a locking device.

In one embodiment, the locking device includes two locking holes arranged on the traction shaft sleeve, wherein a locking ball is arranged in one locking hole, a fixing ball mounting hole arranged on the traction shaft sleeve, wherein a fixing ball is arranged in the fixing ball mounting hole, and a clamping groove arranged on an inner side of the traction cap.

In one embodiment, a torsion device is arranged between the traction cap and the traction shaft sleeve. One end of the torsion device is connected with a first torsion spring mounting hole, and the other end is connected with a second torsion spring mounting hole. The torsion device provides power for a rotation of the traction cap relative to the traction shaft sleeve.

In one embodiment, a limit hole is arranged on the traction shaft sleeve, the limit hole is a long strip and is slotted in a horizontal direction, and a convex limit pin is arranged on an inner side of the traction cap cylinder wall.

In one embodiment, the traction shaft sleeve is composed of three rings with the same inner diameter and different outer diameter of three central shafts in a straight line, namely a first ring, a second ring and a third ring. The outer diameter of the three rings gradually increases from top to bottom. The three rings are formed as a whole. An outer diameter length of the second ring is not greater than an inner diameter length of the traction cap cylinder wall, and the outer diameter of the third ring is the same as that of the traction cap cylinder wall.

In one embodiment, the locking holes are a first locking hole and a second locking hole respectively, and the two locking holes are on the same horizontal plane. A locking ball is arranged in the first locking hole. A diameter of the locking ball is equal to a wall thickness of the second ring. A diameter of the first locking hole is greater than a diameter of the locking ball, and openings on both sides are smaller than the diameter of the locking ball. The second locking hole is empty. A distance between the first locking hole and the second locking hole is equal to a horizontal slotting distance of the limit hole.

In one embodiment, the fixing ball mounting hole corresponds to a position and quantity of clamping grooves in the traction cap cylinder wall. An upper edge of the fixing ball mounting hole is lower than a lower edge of the locking hole. An opening diameter of the fixing ball mounting hole on one side close to a center line of the traction shaft sleeve is less than a diameter of the fixing ball. The diameter of the fixing ball is greater than the wall thickness of the second ring.

In one embodiment, the traction ball joint is provided with a ball joint body. The ball joint body is hemispherical. The ball joint body is connected with a ball handle. The ball handle is cylindrical. A diameter of the ball handle is the same as that of the ball joint body. A ball joint groove is arranged on a side of the ball handle close to the ball joint body, and a certain interval is arranged between the ball joint groove and the ball joint body.

In one embodiment, the number of fixing ball mounting holes and clamping grooves is three.

In one embodiment, the ball joint tractor is further provided with a mounting shaft. The mounting shaft is forked. A forked end is movably connected with the traction shaft sleeve through bolts, and the traction shaft sleeve can be rotated 360°.

The disclosure has the following beneficial effects.

The ball joint tractor provided by the present disclosure is provided with a traction cap. The traction cap is movably connected with a traction shaft sleeve. The traction shaft sleeve is arranged in a cylindrical hollow shape. A traction ball joint can be inserted in a middle of the traction shaft sleeve. The traction cap is provided with a spring plunger mounting hole penetrating through a traction cap cylinder wall and the ball joint tractor is further provided with a locking device. The ball joint tractor has simple structure and convenient operation. When docking is required, it will realize automatic locking, and there is no need for separate personnel to operate. Docking can be completed without getting off the vehicle. The pull ring spring plunger used in the disclosure can be directly inserted into the tractor from the outside of the tractor. When the pull ring spring plunger is damaged, it can be replaced directly without replacing the whole ball joint tractor, which improves the service efficiency of the equipment and avoids the failure of the whole ball joint tractor due to poor spring pin. In the disclosure, by placing the fixing ball in the ball joint groove for locking, the risk of automatic unlocking is avoided, and the safety performance is high and the traction effect is good.

### BRIEF DESCRIPTION OF THE DRAWINGS

FIG. 1 is a structural diagram of the disclosure.

FIG. 2 is a structural diagram of the traction cap.

FIG. 3 is a top view of the traction cap.

FIG. 4 is a structural diagram of the traction shaft sleeve.

FIG. 5 is a sectional view of the locking ball at the position of the first locking hole.

FIG. 6 is a structural diagram of the traction ball joint.

FIG. 7 is a sectional view of the matching state of the traction cap and the traction shaft sleeve when the traction ball joint is not locked.

FIG. 8 is a sectional view of the matching state of the traction cap and the traction shaft sleeve when the traction ball joint is locked.

### DESCRIPTION OF SYMBOLS IN THE FIGURES

1. traction cap;
110. traction cap cylinder wall; 111. spring plunger mounting hole; 112. clamping groove; 113. limit pin;
120. traction cap top; 121. first torsion spring mounting hole; 122. anti-skid protrusion;
2. traction shaft sleeve;
210. first ring;
220. second ring; 221. limit hole; 222. locking hole; 2221. first locking hole; 2222. second locking hole; 223. locking ball; 224. fixing ball mounting hole; 225. fixing ball; 226. second torsion spring mounting hole;
230. third ring; 231. bolt hole;
3. traction ball joint;
310. ball joint body; 320. ball handle; 330. ball joint groove;
4. mounting shaft;
5. pull ring spring plunger.

### DETAILED DESCRIPTION OF THE EMBODIMENTS

In order to make the technical problems, technical solutions and beneficial effects to be solved by the disclosure clearer, the disclosure is further described in detail below in combination with the attached drawings and embodiments. It should be understood that the specific embodiments described herein are only used to explain the disclosure and are not used to limit the disclosure.

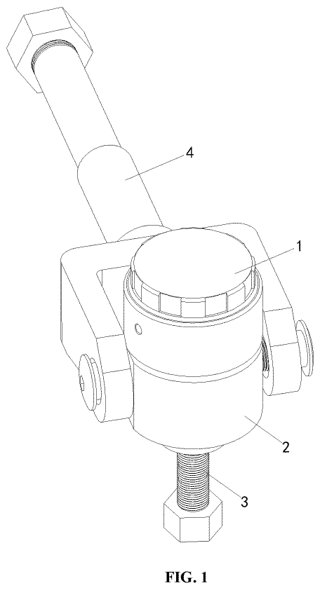

As shown in FIG. 1, a ball joint tractor is provided with a traction cap 1. The traction cap 1 is movably connected with the traction shaft sleeve 2. The traction shaft sleeve 2 is arranged in a cylindrical hollow shape. The traction ball joint 3 can be inserted in the middle of the traction shaft sleeve 2 and lock the traction ball joint 3. The traction shaft sleeve 2 is further provided with a mounting shaft 4. The mounting shaft 4 is movably connected to the traction shaft sleeve 2 through bolts, and the traction shaft sleeve 2 can rotate 360° centered on the bolts.

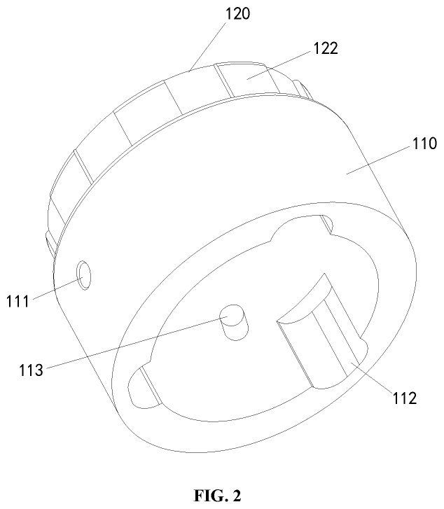

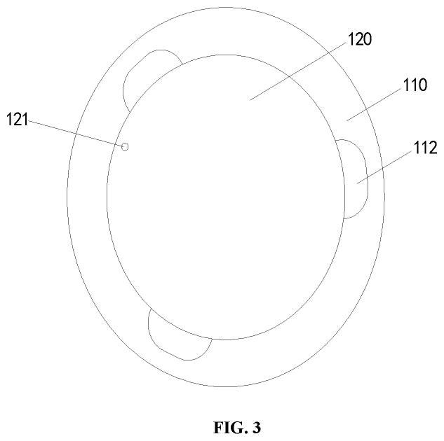

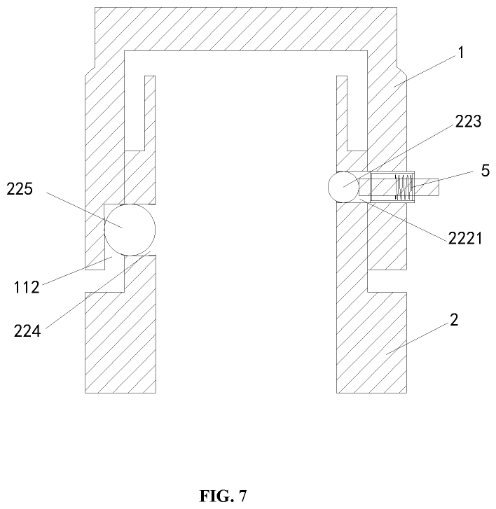

As shown in FIG. 2, FIG. 3 and FIG. 7, the traction cap 1 is a cylindrical shape with a closed top, which is composed of the traction cap cylinder wall 110 and the traction cap top 120. The traction cap cylinder wall 110 and the traction cap top 120 are formed as a whole. The traction cap cylinder wall 110 is provided with a spring plunger mounting hole 111, which penetrates through the traction cap cylinder wall 110. When in use, the pull ring spring plunger 5 is directly installed into the spring plunger mounting hole 111. At least one hemispherical clamping groove 112 is arranged on the inner side of the traction cap cylinder wall 110. In this embodiment, three evenly distributed clamping grooves 112 are arranged. A convex limit pin 113 is arranged on the inner side of the traction cap cylinder wall 110, a first torsion spring mounting hole 121 is arranged inside the traction cap top 120 for fixing one end of the torsion spring, and a rugged and evenly distributed anti-skid protrusion 122 is arranged on the outer edge of the traction cap top 120. The torsion spring used in this embodiment is only one of the specific embodiments, and other torsion devices that can be thought of by those in the art are also included.

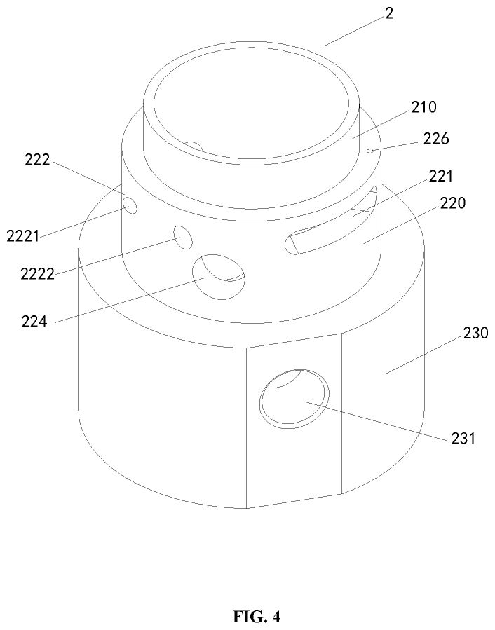

As shown in FIG. 2 and FIG. 4, the traction shaft sleeve 2 is a cylindrical hollow with upper and lower openings. The traction shaft sleeve 2 is composed of three rings with the same inner diameter and different outer diameter of three central shafts in a straight line, namely a first ring 210, a second ring 220 and a third ring 230. The outer diameter of the three rings gradually increases from top to bottom, and the three rings are formed as a whole.

The outer diameter length of the second ring 220 is equal to the inner diameter length of the traction hat cylinder wall 110, and the outer diameter of the third ring 230 is not greater than the outer diameter of the traction hat cylinder wall 110. Therefore, the first ring 210 and the second ring 220 of the traction shaft sleeve 2 can be inserted into the traction hat cylinder wall 110.

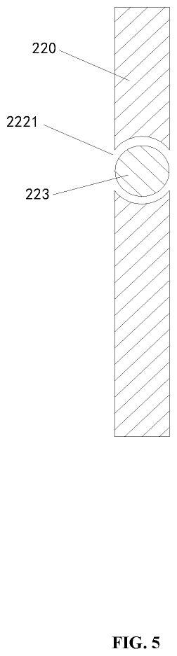

As shown in FIG. 1, FIG. 2, FIG. 4 and FIG. 7, the second ring 220 is provided with a limit hole 221, which is in the shape of a long strip and slotted in the horizontal direction. The limit pin 113 on the traction cap cylinder wall 110 can be inserted into the limit hole 221, and the limit pin 113 can move back and forth in the horizontal direction in the limit hole 221 to limit the rotation of the traction cap 1. The traction shaft sleeve 2 is also provided with two locking holes 222, namely, the first locking hole 2221 and the second locking hole 2222. The two locking holes 222 are on the same horizontal plane, in which the first locking hole 2221 is provided with a locking ball 223, as shown in FIG. 5. The diameter of the locking ball 223 is equal to the wall thickness of the second ring 220, the diameter of the first locking hole 2221 is greater than the diameter of the locking ball 223, and the openings on both sides are smaller than the diameter of the locking ball 223. Therefore, the locking ball 223 can move in the first locking hole 2221 without falling out of the first locking hole 2221. The second locking hole 2222 is empty, and the distance between the first locking hole 2221 and the second locking hole 2222 is equal to the horizontal slotting distance of the limit hole 221. The second ring 220 is also provided with at least one fixing ball mounting hole 224. In this embodiment, the number of fixing ball mounting holes 224 is three. The fixing ball mounting hole 224 corresponds to the position and quantity of the clamping groove 112 inside the traction hat cylinder wall 110. The upper edge of the fixing ball mounting hole 224 is lower than the lower edge of the locking hole 222. The fixing ball 225 is arranged in the fixing ball mounting hole 224. The opening diameter of the fixing ball mounting hole 224 near the centerline of the traction shaft sleeve 2 is less than the diameter of the fixing ball 225. Therefore, the fixing ball 225 will not fall out of the opening on the side of the fixing ball mounting hole 224 close to the center of the traction shaft sleeve 2. The diameter of the fixing ball 225 is greater than the wall thickness of the second ring 220. In this embodiment, one fixing ball 225 is arranged in each of the three fixing ball mounting holes 224. The upper plane of the second ring 220 is provided with a second torsion spring mounting hole 226 for fixing the other end of the torsion spring.

The third ring 230 is also provided with two bolt holes 231, which are respectively located on both sides of the third ring 230 for connecting the mounting shaft 4.

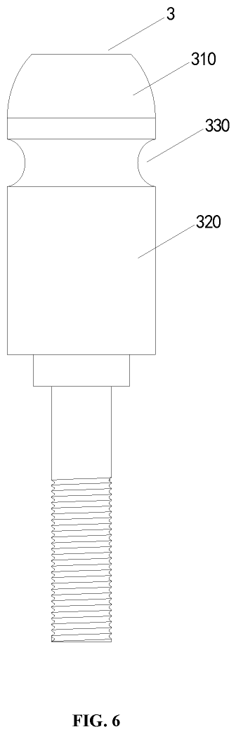

As shown in FIG. 6, the traction ball joint 3 is provided with a ball joint body 310, the ball joint body 310 is hemispherical, and the ball joint body 310 is connected with the ball handle 320. The ball handle 320 is cylindrical, and the diameter of the ball handle 320 is the same as that of the ball joint body 310. A ball joint groove 330 is arranged circumferentially on one side of the ball handle 320 close to the ball joint body 310. A certain interval is arranged between the ball joint groove 330 and the ball joint body 310, and the interval distance is greater than the diameter of the locking hole 222. A bolt is also arranged on the ball handle 320 to fix the traction ball joint 3.

As shown in FIG. 2, FIG. 3, FIG. 4 and FIG. 5, the initial state of the ball joint tractor of the disclosure is as follows. The traction shaft sleeve 2 is placed in the traction cap 1, the limit pin 113 is inserted into the limit hole 221 and is located at one end of the limit hole 221, the torsion spring is located outside the first ring 210, one end of the torsion spring is placed in the first torsion spring mounting hole 121 on the traction cap top 120, the other end is installed in the second torsion spring mounting hole 226 on the second ring 220 of the traction shaft sleeve, and the pull ring spring plunger 5 is inserted into the first locking hole 2221, as shown in FIG. 7. Since a locking ball 223 is arranged in the first locking hole 2221, the pull ring spring plunger 5 is partially inserted into the first locking hole 2221. Under the thrust of the pull ring spring plunger 5, the locking ball 223 is pushed out of the first locking hole 2221. At this time, the torsion spring is in the force storage state, and the traction cap 1 is locked on the traction shaft sleeve 2.

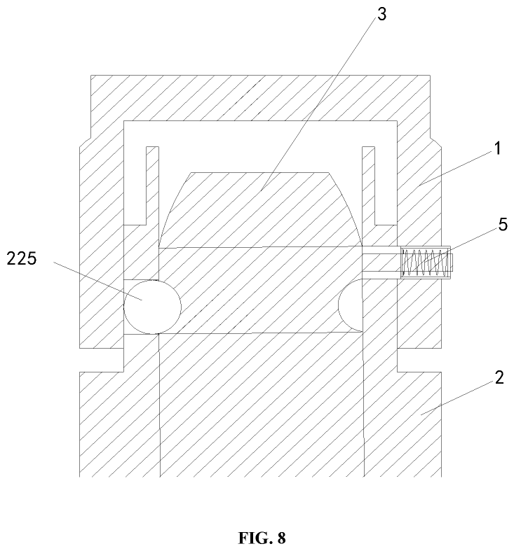

As shown in FIG. 2, FIG. 4, FIG. 7 and FIG. 8, when the pull ring spring plunger 5 is inserted into the first locking hole 2221, the clamping groove 112 is in the same position with the fixing ball mounting hole 224, and the fixing ball 225 is placed between the fixing ball mounting hole 224 and the clamping groove 112. When the traction ball joint 3 enters the traction shaft sleeve 2, the traction ball joint 3 first touches the locking ball 223 and presses the locking ball 223 to one side of the pull ring spring plunger 5, so that the pull ring spring plunger 5 leaves the first locking hole 2221. The traction cap 1 rotates under the action of the torsion spring, the pull ring spring plunger 5 rotates with the traction cap 1, and the limit hole 221 matches with the limit pin 113 to limit the rotation distance of the traction cap 1. The distance between the limit hole 221 and the first locking hole 2221 is the same as that between the first locking hole 2221 and the second locking hole 2222, as shown in FIG. 8, the pull ring spring plunger 5 is inserted into the second locking hole 2222, and the traction cap 1 is locked again. During the rotation of the traction cap 1, the clamping groove 112 rotates the fixing ball 225 so that it is squeezed into the ball joint groove 330 of the traction ball joint 3. The state of the fixing ball 225 changes from FIG. 7 to the position in FIG. 8. Therefore, the traction ball joint 3 is locked in the traction shaft sleeve 2 to complete the automatic locking action of the traction ball joint 3 and the traction shaft sleeve 2. When it is necessary to pull out the traction ball joint 3 from the traction shaft sleeve 2, first the pull ring spring plunger 5 is pulled, and then the traction cap 1 is rotated. The clamping groove 112 coincides with the fixing ball mounting hole 224, the fixing ball 225 is placed in the clamping groove 112 and the fixing ball mounting hole 224, and the traction ball joint 3 is unlocked.

As shown in FIG. 1, the mounting shaft 4 is forked, the forked end is movably connected with the traction shaft sleeve 2 through bolts, and the traction shaft sleeve 2 can be rotated 360°. The other end of the mounting shaft 4 is installed on the trailer through bolts and nuts, and the traction ball joint 3 is installed on the tractor.

The disclosure relates to a ball joint tractor with simple structure and convenient operation. When docking is required, it will realize automatic locking, and there is no need for separate personnel to operate. Docking can be completed without getting off the vehicle. The pull ring spring plunger used in the disclosure can be directly inserted into the tractor from the outside of the tractor. When the pull ring spring plunger is damaged, it can be replaced directly without replacing the whole ball joint tractor, which improves the service efficiency of the equipment and avoids the failure of the whole ball joint tractor due to poor spring pin. In the disclosure, by placing the fixing ball in the ball joint groove for locking, the risk of automatic unlocking is avoided, and the safety performance is high and the traction effect is good.

What is claimed is:

1. A ball joint tractor, wherein the ball joint tractor is provided with a traction cap, the traction cap is movably connected with a traction shaft sleeve, the traction shaft sleeve is arranged in a cylindrical hollow shape, a traction ball joint can be inserted in a middle of the traction shaft sleeve, the traction cap is provided with a spring plunger mounting hole penetrating through a traction cap cylinder wall, and the ball joint tractor is further provided with a locking device.

2. The ball joint tractor of claim 1, wherein the locking device comprises two locking holes arranged on the traction shaft sleeve, wherein a locking ball is arranged in one locking hole; a fixing ball mounting hole arranged on the traction shaft sleeve, wherein a fixing ball is arranged in the fixing ball mounting hole; and a clamping groove arranged on an inner side of the traction cap.

3. The ball joint tractor of claim 1, wherein a torsion device is arranged between the traction cap and the traction shaft sleeve, one end of the torsion device is connected with a first torsion spring mounting hole, the other end is connected with a second torsion spring mounting hole, and the torsion device provides power for a rotation of the traction cap relative to the traction shaft sleeve.

4. The ball joint tractor of claim 1, wherein a limit hole is arranged on the traction shaft sleeve, the limit hole is a long strip and is slotted in a horizontal direction, and a convex limit pin is arranged on an inner side of the traction cap cylinder wall.

5. The ball joint tractor of claim 1, wherein the traction shaft sleeve is composed of three rings with the same inner diameter and different outer diameter of three central shafts in a straight line, namely a first ring, a second ring and a third ring, the outer diameter of the three rings gradually increases from top to bottom, the three rings are formed as a whole, an outer diameter length of the second ring is not greater than an inner diameter length of the traction cap cylinder wall, and the outer diameter of the third ring is the same as that of the traction cap cylinder wall.

6. The ball joint tractor of claim 2, wherein the locking holes are a first locking hole and a second locking hole respectively, the two locking holes are on the same horizontal plane, a locking ball is arranged in the first locking hole, a diameter of the locking ball is equal to a wall thickness of the second ring, a diameter of the first locking hole is greater than a diameter of the locking ball, openings on both sides are smaller than the diameter of the locking ball, the second locking hole is empty, and a distance between the first locking hole and the second locking hole is equal to a horizontal slotting distance of the limit hole.

7. The ball joint tractor of claim 2, wherein the fixing ball mounting hole corresponds to a position and quantity of clamping grooves in the traction cap cylinder wall, an upper edge of the fixing ball mounting hole is lower than a lower edge of the locking hole, an opening diameter of the fixing ball mounting hole on one side close to a center line of the traction shaft sleeve is less than a diameter of the fixing ball, and the diameter of the fixing ball is greater than the wall thickness of the second ring.

8. The ball joint tractor of claim 1, wherein the traction ball joint is provided with a ball joint body, the ball joint body is hemispherical, the ball joint body is connected with a ball handle, the ball handle is cylindrical, a diameter of the ball handle is the same as that of the ball joint body, a ball joint groove is arranged on a side of the ball handle close to the ball joint body, and a certain interval is arranged between the ball joint groove and the ball joint body.

9. The ball joint tractor of claim 7, wherein a number of fixing ball mounting holes and clamping grooves is three respectively.

10. The ball joint tractor of claim 1, wherein the ball joint tractor is further provided with a mounting shaft, the mounting shaft is forked, a forked end is movably connected with the traction shaft sleeve through bolts, and the traction shaft sleeve can be rotated 360°.
